(19) United States
(12) Patent Application Publication
(10) Pub. No.: US 2011/0154805 A1
(43) Pub. Date: Jun. 30, 2011

(54) POWER AUGMENTATION SYSTEM FOR AN ENGINE POWERED AIR VEHICLE

(76) Inventors: Craig Heathco, Martinsville, IN (US); Robert T. Duge, Carmel, IN (US); Steven Arlen Klusman, Indianapolis, IN (US)

(21) Appl. No.: 12/974,976

(22) Filed: Dec. 21, 2010

Related U.S. Application Data
(60) Provisional application No. 61/291,534, filed on Dec. 31, 2009.

(51) Int. Cl. F02C 6/14; F02K 3/00

(52) U.S. Cl. 60/226.1; 60/793

(57) ABSTRACT

One embodiment of the present invention is a unique augmented gas turbine engine propulsion system. Another embodiment is a gas turbine engine power augmentation system. Yet another embodiment is a system for augmenting power in an engine powered air vehicle. Other embodiments include apparatuses, systems, devices, hardware, methods, and combinations for fluid driven actuation systems. Further embodiments, forms, features, aspects, benefits, and advantages of the present application shall become apparent from the description and figures provided herewith.

### CROSS REFERENCE TO RELATED APPLICATIONS

The present application claims the benefit of U.S. Provisional Patent Application 61/291,534, filed Dec. 31, 2009, and is incorporated herein by reference.

### FIELD OF THE INVENTION

The present invention relates to air vehicle systems, and more particularly, to a power augmentation system for an engine powered air vehicle.

### BACKGROUND

Air vehicle power systems remain an area of interest. Some existing systems have various shortcomings, drawbacks, and disadvantages relative to certain applications. Accordingly, there remains a need for further contributions in this area of technology.

### SUMMARY

One embodiment of the present invention is a unique augmented gas turbine engine propulsion system. Another embodiment is a gas turbine engine power augmentation system. Yet another embodiment is a system for augmenting power in an engine powered air vehicle. Other embodiments include apparatuses, systems, devices, hardware, methods, and combinations for power augmentation system. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 schematically illustrates an augmented gas turbine propulsion system for an air vehicle in accordance with an embodiment of the present invention.

FIG. 2 schematically illustrates an augmented gas turbine propulsion system for an air vehicle in accordance with another embodiment of the present invention.

FIG. 3 schematically illustrates an augmented gas turbine propulsion system for an air vehicle in accordance with yet another embodiment of the present invention.

FIG. 4 schematically illustrates a twin engine augmented gas turbine propulsion system for an air vehicle in accordance with an embodiment of the present invention.

FIG. 5 schematically illustrates a twin engine augmented gas turbine propulsion system for an air vehicle in accordance with another embodiment of the present invention.

FIG. 6 schematically illustrates a twin engine augmented gas turbine propulsion system for an air vehicle in accordance with yet another embodiment of the present invention.

FIG. 7 schematically illustrates an embodiment whereby power may be transmitted to or from inertial storage in accordance with an embodiment of the present invention.

### DETAILED DESCRIPTION

For purposes of promoting an understanding of the principles of the invention, reference will now be made to the embodiments illustrated in the drawings, and specific language will be used to describe the same. It will nonetheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

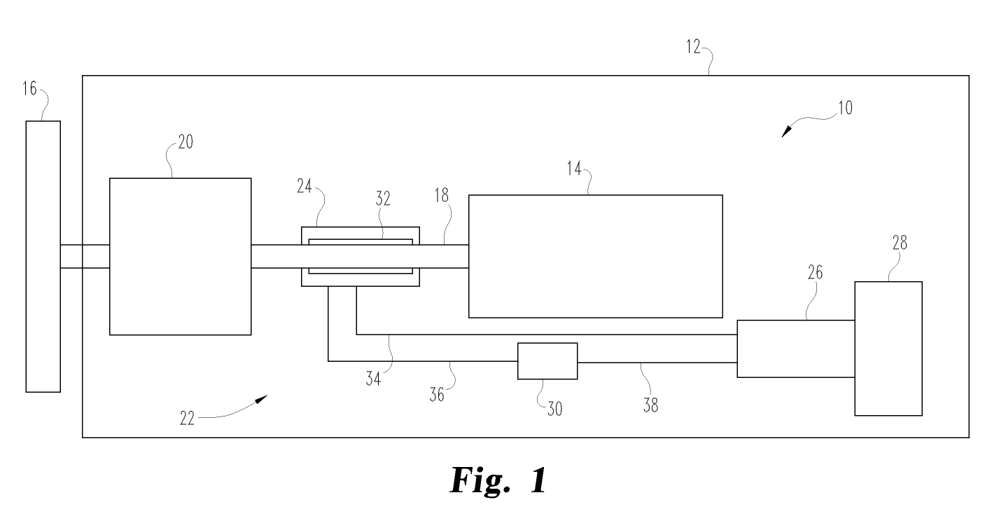

Referring now to the drawings, and in particular FIG. 1, a non-limiting example of an augmented gas turbine engine propulsion system 10 for an air vehicle 12 in accordance with an embodiment of the present invention is schematically depicted. Propulsion system 10 includes a gas turbine engine 14. Gas turbine engine 14 is operative to drive a thrust rotor 16 via a shaft 18 that rotates at the output speed of engine 14. In one form, shaft 18 is an engine 14 spool main shaft, in particular, the output shaft of engine 14. In one form, engine 14 is a turboshaft engine for powering an air vehicle 12 in the form of a rotary wing aircraft, wherein thrust rotor 16 is in the form of a helicopter rotor or a tiltrotor aircraft main rotor. As a rotary-wing aircraft, air vehicle 12 includes a transmission 20. Shaft 18, e.g., an output shaft of engine 14, is coupled to transmission 20 and provides the output from engine 14 to thrust rotor 16 via transmission 20. In some forms, e.g., in helicopter and tiltrotor applications, shaft 18 may alternatively be considered as a transmission input shaft coupled to the output shaft of engine 14 via an overrunning clutch, which allows shaft 18 to rotate when the engine 14 output spool, e.g., the low pressure (LP) spool, is not rotating. Transmission 20 is a step-down transmission that reduces the output speed of engine 14.

In one form, engine 14 is a two-spool engine having an LP spool for driving shaft 18, and a high pressure (HP) spool, e.g., a gas producer or gas generator spool. In some embodiments, the LP spool may include a compressor, whereas in other embodiments, the LP spool may not include a compressor. In other embodiments, engine 14 may be a 3-spool engine having an LP spool, an intermediate pressure spool and an HP spool. In yet other embodiments, engine 14 may be a single-spool engine.

Although described herein with respect to a turboshaft engine for a helicopter, other embodiments may include other air vehicle and gas turbine engine forms. For example, in other embodiments, air vehicle 12 may be in the form of a turboprop fixed-wing aircraft, and engine 14 may be in the form of a turboprop engine with transmission 20 in the form of a turboprop reduction gearbox for driving a thrust rotor 16 in the form of one or more propellers.

In still other embodiments, air vehicle 12 may be in the form of a fixed-wing aircraft, and engine 14 may be in the form of a turbofan engine with thrust rotor 16 in the form of a fan rotor. In one such embodiment, engine 14 may be a geared turbofan engine with transmission 20 in the form of a step-up and/or reduction gearbox. In another such embodiment, engine 14 may be a turbofan engine without a transmission 20, e.g., a direct fan drive, wherein shaft 18 is in the form of a fan driveshaft. It will be understood that various other embodiments may take other forms, including single and multi-engine aircraft having one or more thrust rotors, each being powered by a single or multiple engines 14.

Propulsion system 10 includes a power augmentation system 22. In one form, power augmentation system 22 includes a high speed motor generator 24, a high speed motor generator 26, a flywheel 28 and a controller 30. Power augmentation system 22 is operative to receive and store power from output shaft 18, e.g., during periods of low power demand, such as engine 14 idle or cruise conditions, and to transmit the previously stored power back to output shaft 18. In some embodiments, power augmentation system 22 may also be energized by an external source, e.g., via electrical power supplied by a ground cart or another source of electrical power. In such embodiments, the energy stored in power augmentation system 22 may subsequently be used to power output shaft 18.

High speed motor generator 24 operates at the rotational speed of output shaft 18 of gas turbine engine 14, and is operative to generate electrical power based on the rotation of output shaft 18. In the context of the present application, a motor generator is a “high speed” motor generator if it is configured to operate at rotational speeds substantially greater than 3600 rpm. In one form, a high speed motor generator is a motor generator configured to operate at or greater than the rotational speed of a gas turbine engine spool in an engine with which the motor generator is associated. For example, a motor generator operating at or greater than the speed of the output shaft of a turboshaft engine, the fan drive shaft of a conventional and/or geared turbofan engine, an HP or gas producer spool of a multi-spool engine, and an intermediate pressure spool of a three-spool engine.

Because motor generator 24 is a “high speed” motor generator, a reduction gearbox may not be required in some embodiments, which may prevent the weight penalty associated with such a reduction gearbox. Further, because motor generator 24 is a “high speed” motor generator, the size and weight of motor generator 24 may be smaller than those of a conventional motor generator. In one form, motor generator 24 is coupled directly to output shaft 18, i.e., without an intervening speed/torque conversion mechanism such as a gearbox. Motor generator 24 is operative to rotate at the same rotational speed as output shaft 18. In one form, motor generator 24 includes a motor generator rotor 32 mounted on output shaft 18. In another form, motor generator rotor 32 is integral with output shaft 18. In other embodiments, motor generator rotor 32 may be directly coupled to output shaft 18 without being mounted thereon or integral therewith.

Motor generator 26, like motor generator 24, is a high speed motor generator. Motor generator 26 is electrically coupled to motor generator 24 via an electrical link 34, such as a power cable. Electrical link 34 is operative to transmit electrical power between motor generator 24 and motor generator 26. Motor generator 26 is mechanically coupled to flywheel 28. Flywheel 28 is operative to store inertial energy. Although the term, “flywheel” is used herein, it will be understood that flywheel 28 is not limited to any particular shape, but rather, the term, “flywheel,” is used to refer to a rotating inertial storage rotor, and may be shaped as a wheel, a cylinder, or any other suitable shape. In one form, motor generator 26 is coupled directly to flywheel 28, whereby flywheel 28 and motor generator 26 operate at the same rotational speed. In other embodiments, flywheel 28 and motor generator 26 may operate at some non-unitary fixed or variable speed ratio relative to each other.

Controller 30 is communicatively coupled to motor generator 24 and motor generator 26 via communications links 36 and 38, respectively. In one form, communications links 36 and 38 are wired digital links. In other embodiments, other types of communications links may be employed, e.g., analog links, wireless links, and/or optical links. In still other embodiments, controller 30 may be coupled to motor generator 24 and motor generator 26 via electrical link 34 in addition to or in place of communications links 36 and 38.

Controller 30 is configured to execute program instructions to selectively direct power augmentation system 22 to transmit power from output shaft 18 to flywheel 28, and to transmit power from flywheel 28 to output shaft 18. In one form, controller 30 is microprocessor based and the program instructions are in the form of software stored in a memory (not shown). However, it is alternatively contemplated that the controller and program instructions may be in the form of any combination of software, firmware and hardware, including state machines, and may reflect the output of discreet devices and/or integrated circuits, which may be co-located at a particular location or distributed across more than one location, including any digital and/or analog devices configured to achieve the same or similar results as a processor-based controller executing software or firmware based instructions. For example, in one form, controller 30 may be part of a full authority digital engine controller (FADEC) of engine 14. As another non-limiting example, controller 30 may be integral with one or both of motor generator 24 and motor generator 26. As yet another example, controller 30 may be in the form of switches or switching circuitry.

Power augmentation system 22 is operative to receive and store power from output shaft 18 and to transmit the stored power back to output shaft 18 in order to augment the output of engine 14. For example, in one form, output shaft 18 is rotated, e.g., under the power of engine 14 or via windmilling of thrust rotor 16. Under the control supervision of controller 30, the mechanical power is absorbed by motor generator 24, which converts the mechanical power into electrical power. The electrical power is then transmitted to motor generator 26 via electrical link 34. Under the direction of controller 30, motor generator 26 converts the electrical power back into mechanical power, which is absorbed by flywheel 28 in the form of rotating inertial energy. Upon receiving a command to augment power to thrust rotor 16, motor generator 26 absorbs mechanical power from flywheel 28 and converts the mechanical power to electrical power under the direction of controller 30. The electrical power is then transmitted to motor generator 24 via electrical link 34. Motor generator 24 then converts the electrical power into mechanical power under the direction of controller 30, which is transmitted to output shaft 18 by motor generator rotor 32.

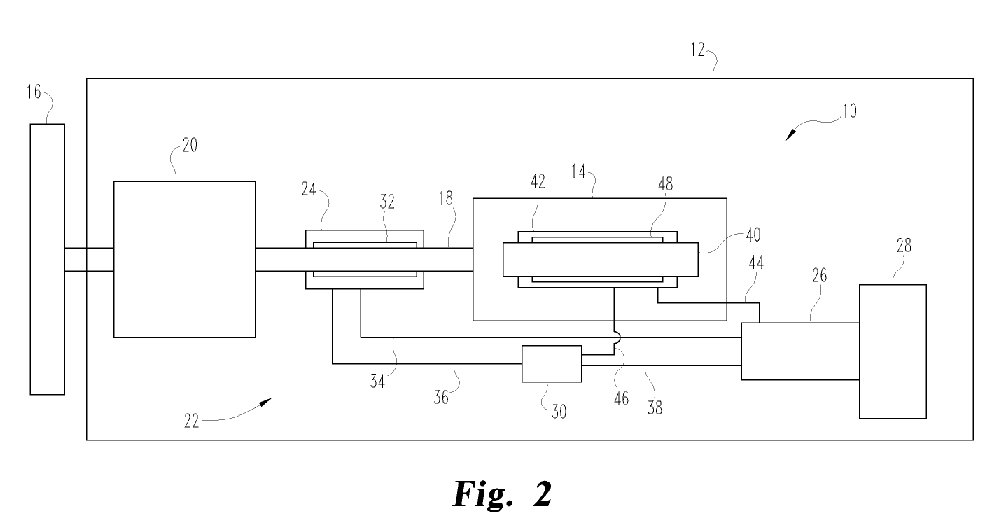

Referring now to FIG. 2, another embodiment of engine 14 with power augmentation system 22 is described. In the embodiment of FIG. 2, engine 14 is a multi-spool engine in which output shaft 18 is part of the LP spool. Engine 14 includes an HP spool as a gas producer, which includes a main shaft, such as a gas producer shaft 40. In addition to motor generator 24 and motor generator 26, power augmentation system 22 also includes a high speed motor generator 42 mechanically coupled to gas producer shaft 40. Motor generator 42 is electrically coupled to motor generator 26 via an electrical link 44, such as a power cable, and communicatively coupled to controller 30 via a communications link 46, similar to that described above with respect to the embodiment of FIG. 1.

In one form, high speed motor generator 42 is directly coupled to gas producer shaft 40, i.e., without an intervening speed/torque conversion mechanism such as a gearbox. Motor generator 42 is operative to rotate at the same rotational speed as gas producer shaft 40. In one form, motor generator 42 includes a motor generator rotor 48 mounted on gas producer shaft 40. In another form, motor generator rotor 48 is integral with gas producer shaft 40. In other embodiments, motor generator rotor 48 may be directly coupled to gas producer shaft 40 without being mounted thereon or integral therewith. In still other forms, motor generator rotor 48 may be coupled to gas producer shaft 40 via a speed increasing or speed reducing gear train, such as an accessory drive system (not shown).

With the embodiment of FIG. 2, controller 30 is configured to execute program instructions to selectively direct power augmentation system 22 to transmit power from motor generator 42 to motor generator 26. Power may thus be extracted from gas producer shaft 40 and stored in flywheel 28 for subsequent use at output shaft 18. Extracting power from the gas producer requires engine 14 to operate at lower flows and higher temperatures, which may in some embodiments increase part power efficiency of engine 14. Such part power efficiency improvements may be more pronounced in an engine 14 having a heat recovery system, such as a recuperator.

As an example of transferring power from gas producer shaft 40 to flywheel 28, engine 14 is operated to rotate gas producer shaft 40. Under the direction of controller 30, mechanical power from gas producer shaft 40 is absorbed by motor generator 42, which converts the mechanical power into electrical power. The electrical power is then transmitted to motor generator 26 via electrical link 44. Under the direction of controller 30, motor generator 26 converts the electrical power back into mechanical power, which is absorbed by flywheel 28 in the form of rotating inertial energy. Upon receiving a command to augment power to thrust rotor 16, motor generator 26 absorbs mechanical power from flywheel 28 and converts the mechanical power to electrical power under the direction of controller 30. The electrical power is then transmitted to motor generator 24 via electrical link 34. Motor generator 24 then converts the electrical power into mechanical power under the direction of controller 30, which is transmitted to output shaft 18 by motor generator rotor 32.

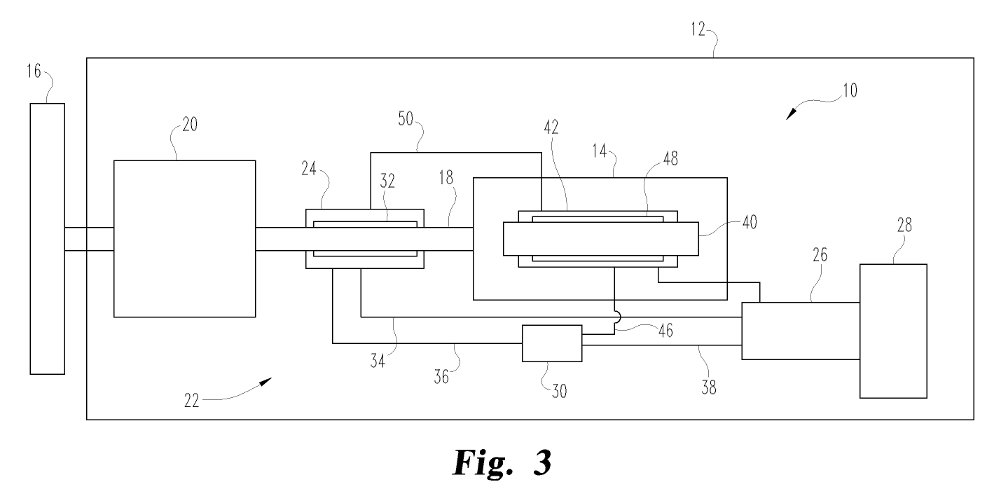

Referring now to FIG. 3, another embodiment of engine 14 with power augmentation system 22 is described. FIG. 3 is similar to the embodiment of FIG. 2, except that motor generator 42 is electrically coupled to motor generator 24 via an electrical link 50, such as a power cable, instead of being coupled to motor generator 26 via electrical link 44. It will be understood that in other embodiments, motor generator 42 may be electrically coupled to both motor generator 24 and motor generator 26. In the embodiment of FIG. 3, controller 30 is configured to execute program instructions to selectively direct power augmentation system 22 to transmit power from motor generator 42 to motor generator 24. The embodiment of FIG. 3 allows the transfer of power from gas producer shaft 40 directly to output shaft 18, which may increase the part power efficiency of engine 14, as set forth above with respect to the embodiment of FIG. 2.

As an example of transferring power from gas producer shaft 40 to output shaft 18, engine 14 may be operated to rotate gas producer shaft 40. Under the direction of controller 30, mechanical power from gas producer shaft 40 is absorbed by motor generator 42, which converts the mechanical power into electrical power. Under the direction of controller 30, the electrical power is transmitted to motor generator 24 via electrical link 50. Motor generator 26 converts the electrical power back into mechanical power, which is transmitted to output shaft 18 by motor generator rotor 32.

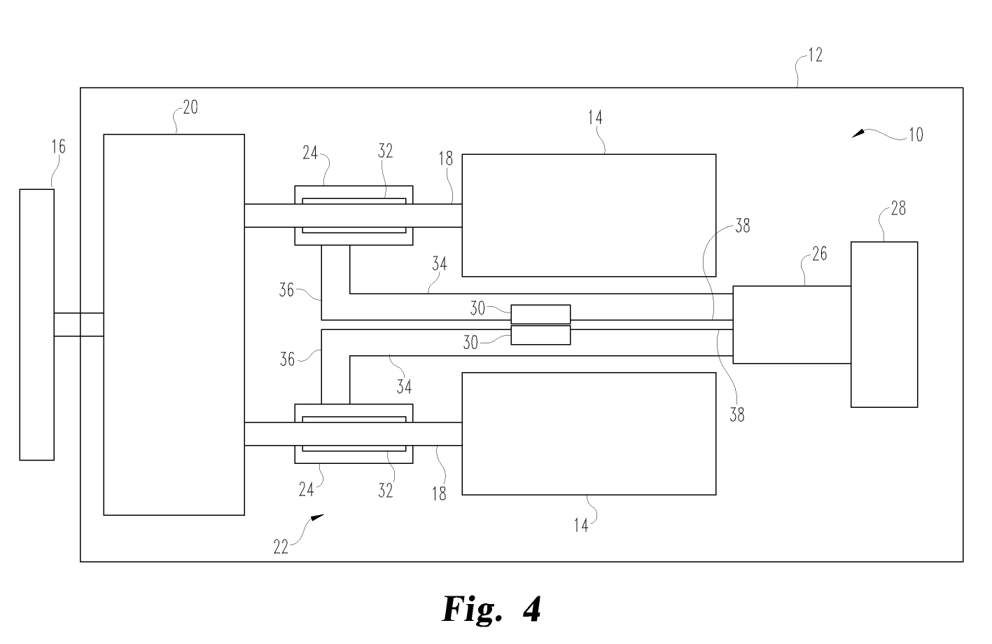

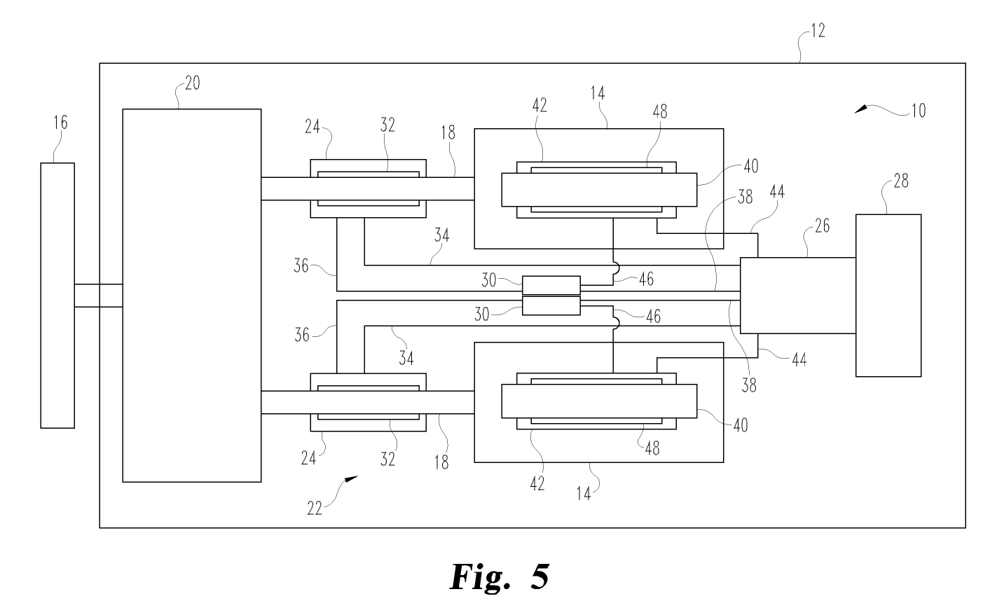

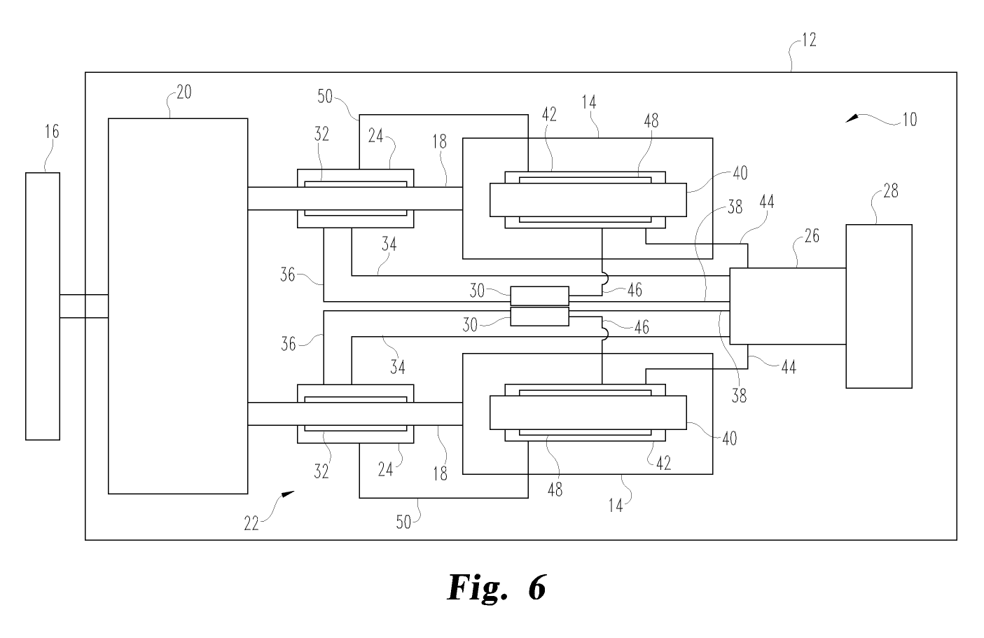

Referring now to FIGS. 4, 5 and 6, some many possible additional embodiments are illustrated. In the embodiments of FIGS. 4-6, each transmission 20 is powered by two engines 14. The embodiment of FIG. 4 may be considered a twin-engine version of the embodiment of FIG. 1. In the embodiment of FIGS. 4-6, a single motor generator 26 and flywheel 28 are employed. In the embodiment of FIG. 4, each motor generator 24 is electrically coupled to the common motor generator 26. In the embodiment of FIG. 5, each motor generator 24 and each motor generator 42 are electrically coupled to the common motor generator 26. In the embodiment of FIG. 6, each motor generator 24 is electrically coupled to the common motor generator 26, and each motor generator 42 is electrically coupled to the motor generator 24 corresponding to the same engine 14.

Power augmentation system 22 may store energy in flywheel 28 for subsequent use to provide power to thrust rotor 16. In some embodiments, power augmentation system 22 energizes flywheel 28 by extracting mechanical power from the operation of engine 14. For example, during part power engine 14 operation, e.g., ground idle, flight idle, ascent, descent or cruise power settings, energy may be stored in flywheel 28, e.g., by converting mechanical power to electrical power using motor generator 24 and/or motor generator 42, depending upon the embodiment. The electrical power is then converted to mechanical power by motor generator 26 and stored in flywheel 28 as inertial energy.

In other embodiments, power from a helicopter or tiltrotor main rotor (thrust rotor 16) is used to rotate output shaft 18 and provide mechanical power, e.g., during the descent phase of an autorotation landing. The mechanical power is received by power augmentation system 22 and stored in flywheel 28. Power augmentation system 22 may then be used to transmit the power back to output shaft 18 in order to provide power to the main rotor during the landing flare, e.g., which may aid flight safety and the landing of the air vehicle.

In still other embodiments, all or part of power augmentation system 22 may aid in performing a ground or in-flight startup of an engine 14. For example, in one form, energy stored in flywheel 28 may be used to rotate the output shaft of a single shaft engine 14 via motor generator 24, which in some embodiments may be performed on the ground and/or during flight operations. In another form, energy stored in flywheel 28 may be used to rotate the gas producer shaft of a multi-spool engine 14 via motor generator 42, which in some embodiments may be performed on the ground and/or during flight operations. In yet another form, electrical power may be generated via motor generator 24 during windmilling, e.g., of a fan rotor, a helicopter rotor or a propeller, which may be supplied to the gas producer of a multi-spool engine via motor generator 42 and/or motor generator 26, which may be used to start or aid in starting engine 14.

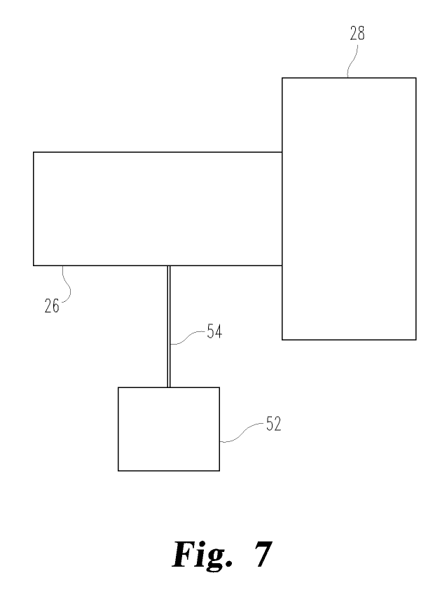

In yet still other embodiments flywheel 28 may be energized by another source of electrical power, e.g., a ground cart, and in some embodiments, the energy stored in flywheel 28 may be used to provide power to other devices in addition to or in place of output shaft 18. For example, referring now to FIG. 7, in some embodiments, motor generator 26 may electrically coupled to a system 52 via an electrical link 54, such as a power cable. System 52 may take various forms in different embodiments. For example, in one form, system 52 may be a static power source, such as a land-based power system, a land-based electrical grid and/or a ground cart, which may be used to energize flywheel 28 by providing electrical power to motor generator 26.

The power delivered by power augmentation system 22 may be utilized for many other purposes. For example, in one exemplary form, a sizing feature for a twin-engine helicopter includes a one engine inoperative (OEI) rating, which may be two minutes, with a higher emergency rating of 30 seconds. Energy stored in flywheel 28 may be employed to increase the OEI capability of the engine by providing additional power.

As another example, electronic weapons such as lasers or other high energy weapons often require bursts of transient power. For example, referring again to FIG. 7, in one form, system 52 may be an electronic or other weapon system that requires bursts of transient power. In some embodiments, an aircraft fitted with power augmentation system 22 may use the energy stored in flywheel 28 to power the weapon, by converting the mechanical energy stored in flywheel 28 to electrical energy with motor generator for use by the weapon system.

As yet another example, helicopters and tiltrotor aircraft require substantial amounts of power to hover prior to gaining forward velocity and translational lift. By energizing flywheel 28 prior to takeoff, the energy stored in flywheel 28 may be subsequently extracted by power augmentation system 22 during takeoff.

As still another example, gas turbine engine 14 thermodynamic output may be reduced during critical operations and augmented by power augmentation system 22, which may reduce engine noise and heat signature, e.g., during stealth operations.

As yet still another example, peak power demands and transient power demands are typically the parameters used to size a gas turbine engine core, e.g., to determine the maximum power rating for the engine. However, the air vehicle typically operates at a fraction of the maximum available power. Fuel efficiency at part power is typically much less than when operating at the maximum power design point. By sizing the gas turbine engine to account for the power that may be provided by power augmentation system 22, the peak power demands from the gas turbine engine are reduced. This may allow for the use of a smaller gas turbine engine core that, under normal operating conditions such as cruise conditions, operates closer to design point. In some embodiments, this may potentially yield increased efficiency relative to propulsions systems that do not include a power augmentation system such as power augmentation system 22.

As a further example, power augmentation system 22 may be used to transfer power from gas producer shaft 40 to output shaft 18 as set forth above with respect to FIG. 2.

As a yet further example, power augmentation system 22 may be energized by an aircraft prior to leaving the gate (e.g., at an airport), and then subsequently used to power electric drive motors in the aircraft wheels. This may allow an aircraft to taxi to the runway without idling the main engine, which may reduce noise, fuel usage, exhaust emissions and noise.

Embodiments of the present invention include an augmented gas turbine engine propulsion system for an air vehicle, comprising: a gas turbine engine having an output shaft operative to drive a thrust rotor for the air vehicle; and a power augmentation system coupled to the output shaft and operative to receive and store power from the output shaft and to transmit power to the output shaft, the power augmentation system including: a first high speed motor generator coupled directly to the output shaft and operative to rotate at a same rotational speed as the output shaft; a flywheel operative to store inertial energy; and a second high speed motor generator electrically coupled to the first high speed motor generator and mechanically coupled to the flywheel.

In a refinement, the augmented gas turbine engine propulsion system further includes a controller communicatively coupled to the first high speed motor generator and the second high speed motor generator, wherein the controller is configured to execute program instructions to selectively direct the power augmentation system to transmit power from the output shaft to the flywheel and to transmit power from the flywheel to the output shaft.

In another refinement, the first high speed motor generator includes a motor generator rotor mounted on the output shaft.

In yet another refinement, the first high speed motor generator includes a motor generator rotor integral with the output shaft.

In still another refinement, the air vehicle is a rotary wing aircraft, and wherein the thrust rotor is a helicopter main rotor.

In yet still another refinement, the air vehicle is a fixed wing aircraft, and wherein the thrust rotor is a propeller.

In a further refinement, the output shaft is a fan drive shaft, and the augmented gas turbine engine propulsion system further includes a fan rotor, wherein the air vehicle is a fixed wing aircraft, and wherein the thrust rotor is the fan rotor.

In a yet further refinement, the gas turbine engine is a multi-spool engine, and wherein the output shaft is a main shaft of a first spool of the gas turbine engine, further comprising a third high speed motor generator mechanically coupled to a second spool of the gas turbine engine and electrically coupled to the second high speed motor generator.

Embodiments also include a gas turbine engine power augmentation system, comprising: a first high speed motor generator coupled directly to an output shaft of the gas turbine engine and operative to rotate at a same rotational speed as the output shaft; a flywheel operative to store inertial energy; and a second high speed motor generator electrically coupled to the first high speed motor generator and mechanically coupled to the flywheel, wherein the power augmentation system is operative to receive and store power from the output shaft and to transmit power to the output shaft.

In a refinement, the gas turbine engine power augmentation system further includes a controller communicatively coupled to the first high speed motor generator and the second high speed motor generator, wherein the controller is configured to execute program instructions to selectively direct the power augmentation system to transmit power from the output shaft to the flywheel and to transmit power from the flywheel to the output shaft.

In another refinement, the gas turbine engine is a multi-spool engine, and the output shaft is a main shaft of a first spool of the gas turbine engine, wherein the gas turbine engine power augmentation system further includes a third high speed motor generator mechanically coupled to a main shaft of a second spool of the gas turbine engine.

In yet another refinement, the third high speed motor generator is electrically coupled the first high speed motor generator.

In still another refinement, the gas turbine engine power augmentation system further includes a controller communicatively coupled to the first high speed motor generator and the third high speed motor generator, wherein the controller is configured to execute program instructions to selectively direct the power augmentation system to transmit power from the third high speed motor generator to the first high speed motor generator.

In yet still another refinement, the third high speed motor generator is electrically coupled to the second high speed motor generator.

In a further refinement, the gas turbine engine power augmentation system further includes a controller communicatively coupled to the second high speed motor generator and the third high speed motor generator, wherein the controller is configured to execute program instructions to selectively direct the power augmentation system to transmit power from the third high speed motor generator to the second high speed motor generator.

In a still further refinement, the third high speed motor generator is electrically coupled to both the first high speed motor generator and the second high speed motor generator.

In yet still a further refinement, the second spool is a gas producer spool, and the third high speed motor generator includes a motor generator rotor mounted on the main shaft of the gas producer spool.

In an additional refinement, the second spool is a gas producer spool, and the third high speed motor generator includes a motor generator rotor integral with the main shaft of the gas producer spool.

Embodiments also include a system for augmenting power in an engine powered air vehicle, comprising: means for rotating an output shaft of the engine to provide a first mechanical power at the output shaft; means for converting the first mechanical power at the output shaft into a first electrical power; means for converting the first electrical power into a second mechanical power; means for storing the second mechanical power in the form of an inertial energy; means for converting the inertial energy into a second electrical power; and means for converting the second electrical power into a third mechanical power at the output shaft.

In a refinement, the system also includes means for rotating a gas producer shaft of the engine to provide a fourth mechanical power; means for converting the fourth mechanical power into a third electrical power; and means for transmitting the third electrical power to one of: the means for converting the first electrical power into a second mechanical power; and the means for converting the second electrical power into a third mechanical power at the output shaft.

In another refinement, the system further includes means for providing a fourth electrical power from a static power source to the means for converting the first electrical power into the second mechanical power.

In yet another refinement, the system further includes means for powering a weapon system using the means for converting the inertial energy into the second electrical power.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An augmented gas turbine engine propulsion system for an air vehicle, comprising:
a gas turbine engine having an output shaft operative to drive a thrust rotor for said air vehicle; and
a power augmentation system coupled to said output shaft and operative to receive and store power from said output shaft and to transmit power to said output shaft, said power augmentation system including:
a first high speed motor generator coupled directly to said output shaft and operative to rotate at a same rotational speed as said output shaft;
a flywheel operative to store inertial energy; and
a second high speed motor generator electrically coupled to said first high speed motor generator and mechanically coupled to said flywheel.

2. The augmented gas turbine engine propulsion system of claim 1, further comprising a controller communicatively coupled to said first high speed motor generator and said second high speed motor generator, wherein said controller is configured to execute program instructions to selectively direct said power augmentation system to transmit power from said output shaft to said flywheel and to transmit power from said flywheel to said output shaft.

3. The augmented gas turbine engine propulsion system of claim 1, wherein said first high speed motor generator includes a motor generator rotor mounted on said output shaft.

4. The augmented gas turbine engine propulsion system of claim 1, wherein said first high speed motor generator includes a motor generator rotor integral with said output shaft.

5. The augmented gas turbine engine propulsion system of claim 1, wherein said air vehicle is a rotary wing aircraft, and wherein said thrust rotor is a helicopter main rotor.

6. The augmented gas turbine engine propulsion system of claim 1, wherein said air vehicle is a fixed wing aircraft, and wherein said thrust rotor is a propeller.

7. The augmented gas turbine engine propulsion system of claim 1, wherein said output shaft is a fan drive shaft, further comprising a fan rotor, wherein said air vehicle is a fixed wing aircraft, and wherein said thrust rotor is said fan rotor.

8. The augmented gas turbine engine propulsion system of claim 1, wherein said gas turbine engine is a multi-spool engine, and wherein said output shaft is a main shaft of a first spool of said gas turbine engine, further comprising a third high speed motor generator mechanically coupled to a second spool of said gas turbine engine and electrically coupled to said second high speed motor generator.

9. A gas turbine engine power augmentation system, comprising:
a first high speed motor generator coupled directly to an output shaft of said gas turbine engine and operative to rotate at a same rotational speed as the output shaft;
a flywheel operative to store inertial energy; and
a second high speed motor generator electrically coupled to said first high speed motor generator and mechanically coupled to said flywheel,
wherein said power augmentation system is operative to receive and store power from the output shaft and to transmit power to the output shaft.

10. The gas turbine engine power augmentation system of claim 9, further comprising a controller communicatively coupled to said first high speed motor generator and said second high speed motor generator, wherein said controller is configured to execute program instructions to selectively direct said power augmentation system to transmit power from the output shaft to said flywheel and to transmit power from said flywheel to the output shaft.

11. The gas turbine engine power augmentation system of claim 9, wherein said gas turbine engine is a multi-spool engine, and wherein the output shaft is a main shaft of a first spool of the gas turbine engine, further comprising a third high speed motor generator mechanically coupled to a main shaft of a second spool of the gas turbine engine.

12. The gas turbine engine power augmentation system of claim 11, wherein said third high speed motor generator is electrically coupled said first high speed motor generator.

13. The gas turbine engine power augmentation system of claim 12, further comprising a controller communicatively coupled to said first high speed motor generator and said third high speed motor generator, wherein said controller is configured to execute program instructions to selectively direct said power augmentation system to transmit power from said third high speed motor generator to said first high speed motor generator.

14. The gas turbine engine power augmentation system of claim 11, wherein said third high speed motor generator is electrically coupled to said second high speed motor generator.

15. The gas turbine engine power augmentation system of claim 14, further comprising a controller communicatively coupled to said second high speed motor generator and said third high speed motor generator, wherein said controller is configured to execute program instructions to selectively direct said power augmentation system to transmit power from said third high speed motor generator to said second high speed motor generator.

16. The gas turbine engine power augmentation system of claim 11, wherein said third high speed motor generator is electrically coupled to both said first high speed motor generator and said second high speed motor generator.

17. The gas turbine engine power augmentation system of claim 11, wherein the second spool is a gas producer spool, and wherein said third high speed motor generator includes a motor generator rotor mounted on the main shaft of the gas producer spool.

18. The gas turbine engine power augmentation system of claim 11, wherein the second spool is a gas producer spool, and wherein said third high speed motor generator includes a motor generator rotor integral with the main shaft of the gas producer spool.

19. A system for augmenting power in an engine powered air vehicle, comprising:
means for rotating an output shaft of the engine to provide a first mechanical power at the output shaft;
means for converting the first mechanical power at the output shaft into a first electrical power;
means for converting the first electrical power into a second mechanical power;
means for storing the second mechanical power in the form of an inertial energy;
means for converting the inertial energy into a second electrical power; and
means for converting the second electrical power into a third mechanical power at the output shaft.

20. The system of claim 19, further comprising:
means for rotating a gas producer shaft of the engine to provide a fourth mechanical power;
means for converting the fourth mechanical power into a third electrical power; and
means for transmitting the third electrical power to one of:
said means for converting the first electrical power into a second mechanical power; and
said means for converting the second electrical power into a third mechanical power at the output shaft.

21. The system of claim 19, further comprising:
means for providing a fourth electrical power from a static power source to said means for converting the first electrical power into the second mechanical power.

22. The system of claim 19, further comprising means for powering a weapon system using said means for converting the inertial energy into the second electrical power.
